(19) United States
(12) Patent Application Publication
(10) Pub. No.: US 2012/0166846 A1
(43) Pub. Date: Jun. 28, 2012

(54) USB SYSTEM AND POWER MANAGEMENT MODULE AND METHOD THEREOF

(75) Inventors: PAO CHEN WU, HSINCHU COUNTY (TW); JIH CHUN TSAI, HSINCHU COUNTY (TW); PING WEI WU, HSINCHU COUNTY (TW)

(73) Assignee: RALINK TECHNOLOGY CORPORATION, HSINCHU COUNTY (TW)

(21) Appl. No.: 13/328,473

(22) Filed: Dec. 16, 2011

(30) Foreign Application Priority Data
Dec. 22, 2010 (TW) 099145139

(51) Int. Cl. G06F 1/00

(52) U.S. Cl. 713/323; 713/300

(57) ABSTRACT

A power management module is configured to set up a power mode of a computer system. A peripheral device having a Universal Serial Bus (USB) is connected to the computer system. The power management module includes an Operating System (OS) and a filter driver. The OS is configured to set up the power mode of the computer system, and the filter driver is configured to change the power mode of the computer system according to a packet transmitting/receiving status of the peripheral device.

### BACKGROUND OF THE INVENTION

1. Field of the Invention

The present invention relates to a Universal Serial Bus (USB) system and a power management module and a method thereof.

2. Description of the Related Art

A USB is a serial port bus standard connecting a computer system and an external device. Due to advantages of hot plug and Plug and Play (PNP), the USB interface has become a mainstream transmission interface. When a USB device is connected to or removed from a host system, the power of the host system does not need to be switched off and then switched on again. In addition, a user only needs to connect the USB device to the host system to operate the USB device immediately, and does not need to worry about any issue related to installation or setup.

FIG. 1 shows a block diagram of a composition of a conventional USB system 10. Referring to FIG. 1, a host computer system 11 can be coupled to different peripheral devices such as a keyboard 14, a mouse 16, or a wireless network card 18 through a USB 12. Meanwhile, a display unit or a monitor can be coupled to the host computer system 11 through a video cable.

The host computer system 11 may include an Operating System (OS) 112, a USB device driving program 114, a USB driving program 116, and a USB host controller driving program 118. The OS 112 is responsible for managing and maintaining communication between the host computer system 11 and the USB peripheral devices. The USB device driving program 114 includes a program code describing features of the USB peripheral devices, so that the host computer system 11 can access the USB peripheral devices, for example, read data from the peripheral device, write data to the peripheral device, transmit a command to the peripheral device, or receive status data related to the peripheral device. The USB device driving program 114 may send a request to the USB driving program 116 through an I/O Request Packet (IRP). The USB driving program 116 is a software interface providing a USB serial transmission mechanism. When the USB driving program 116 receives an IRP from the USB device driving program 114, the USB driving program 116 organizes the IRP into an individual processing action, so as to execute the action in a continuous frame. The USB host controller driving program 118 in FIG. 1 is responsible for scheduling a time course of the processing action broadcasted on the USB 12.

Currently available USB transmission lines support a Network Device Interface Standard (NDIS). Under this standard, when the host computer system 10 detects attachment of the USB peripheral devices (particularly a wireless network card 18), the host computer system 10 operates in a normal power mode, so as to access the wireless network card 18. However, when the wireless network card 18 is in an idle status, that is, the wireless network card 18 is not transmitting a packet, the host computer system 11 is limited by the NDIS and fails to enter a power saving mode, thereby causing unnecessary power consumption.

Therefore, it is necessary to provide a power management device and a method thereof applied to a computer system. When a USB peripheral device is attached to the host computer system, the host computer system can operate in a power saving mode, so as to reduce the power loss.

### SUMMARY OF THE INVENTION

The present invention discloses a power management module and a method thereof, configured to set up a power mode of a computer system. A peripheral device having a USB is connected to the computer system. An embodiment of the present invention discloses a power management module, which includes an OS and a filter driver. The OS is configured to set up the power mode of the computer system, and the filter driver is configured to change the power mode of the computer system according to a packet transmitting/receiving status of the peripheral device.

Another embodiment of the present invention discloses a USB system, which includes a peripheral device and a host device. The peripheral device communicates with a host device through a USB. The host device includes an OS, which is configured to set up a power mode of the host device. The host device further includes a filter driver, which is configured to change the power mode of the host device according to a packet transmitting/receiving status of the peripheral device.

Still another embodiment of the present invention discloses a power management method, which is used to set up a power mode of a computer system. A peripheral device having a USB is connected to the computer system. The method includes the following steps: detecting a packet transmitting/receiving status of the peripheral device through a filter driver; generating a Power IRP (PIRP) through the filter driver when the peripheral device is not receiving or transmitting a packet; and changing the mode of the computer system from a normal power mode to a power saving mode according to the PIRP.

### BRIEF DESCRIPTION OF THE DRAWINGS

The invention will be described according to the appended drawings in which:

FIG. 1 is a block diagram of a composition of a conventional USB system;

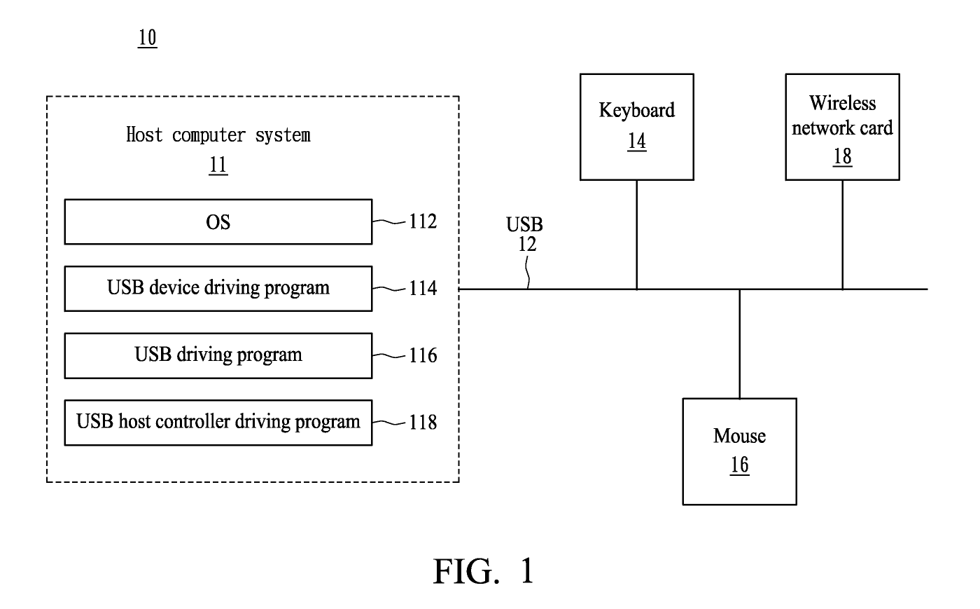

FIG. 2 is a block diagram of a composition of a USB system according to an embodiment of the present invention; and

FIG. 3 is a flow chart of a power management method according to an embodiment of the present invention.

### PREFERRED EMBODIMENT OF THE PRESENT INVENTION

The present invention is directed to a power management module and a method thereof applied to a computer system. For thorough understanding of the present invention, detailed steps and structures are provided in the following description. Obviously, the implementation of the present invention is not limited to special details familiar to those skilled in the art. In another aspect, structures or steps known to all are not described in detail, so as to avoid unnecessary limitation to the present invention. The preferred embodiments of the present invention will be described below. However, apart from these detailed descriptions, the present invention may further be implemented in other embodiments. The scope of the present invention is not limited, and is subject to the scope of the appended claims.

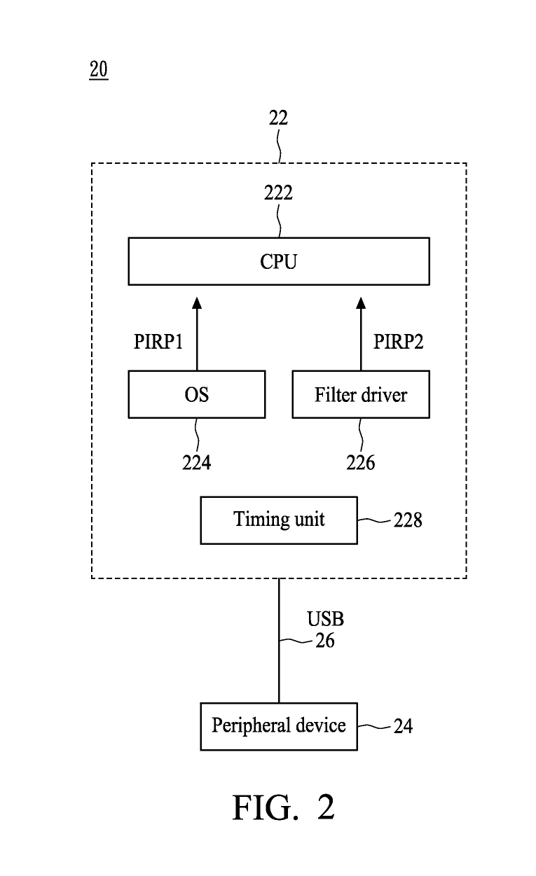

In order to clearly illustrate the power management method of the present invention, a USB system executing the method of the present invention will be described first as follows. FIG. 2 is a block diagram of a composition of a USB system 20 according to an embodiment of the present invention. The USB system 20 includes a host device 22 and a peripheral device 24. The host device 22 may be a personal computer (such as a desktop computer, a notebook computer, a flat-panel computer, or other proper computer devices), a Personal Digital Assistant (PDA), a wireless communication device (such as a cellular phone, an embedded controller, or other proper devices or combinations thereof). The peripheral device 24 is a packet transmitting/receiving device (such as a wireless network card). The peripheral device 24 communicates with the host device 22 through a USB transmission line 26. The USB transmission line 26 supports an NDIS.

Referring to FIG. 2, the host device 22 includes a Central Processing Unit (CPU) 222, an OS 224, and a filter driver 226. When the host device 22 is started, the OS 224 can be uploaded to a Random Access Memory (RAM) and executed therein. According to an operating status of the host device 22 and the peripheral device 24, the OS 224 can adjust a power mode of the host device 22. The filter driver 226 interacts with the OS 224 through software code. The software code in the filter driver 226 can be uploaded to the RAM, and the code can be executed when the host device 22 is on.

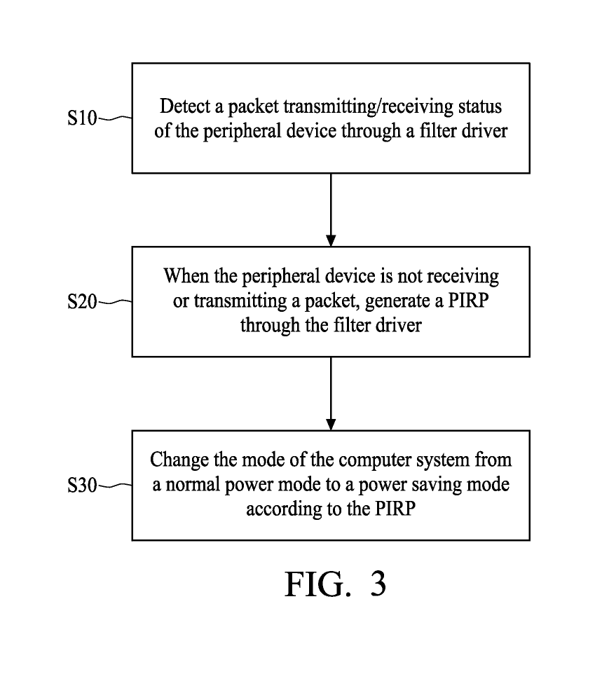

FIG. 3 is a flow chart of a power management method according to an embodiment of the present invention. The power management method is applied to set up a power mode of a computer system. A peripheral device having a USB is connected to the computer system. The power management method includes the following steps: detecting a packet transmitting/receiving status of the peripheral device through a filter driver (Step S10); generating a PIRP through the filter driver when the peripheral device is not receiving or transmitting a packet (Step S20); and changing the mode of the computer system from a normal power mode to a power saving mode according to the PIRP (Step S30). Details of the power management method of the present invention will be further described with reference to FIG. 2.

Referring to FIG. 2, when a normally operating peripheral device 24 is connected to a host device 22, a power mode of the host device 22 is set up by an OS 224. The OS 224 sends a PIRP1 to the CPU 222, so that the host device 22 operates in a normal power mode. During the operation, a filter driver 226 of the host device 22 continuously detects an IRP sent by the peripheral device 24, so as to determine an operating status of the peripheral device 24.

If the peripheral device 24 is in an idle status, that is, the peripheral device 24 does not receive or transmit a packet, after detecting the idle status, the filter driver 226 generates a PIRP2 to a CPU 222 of the host device 22, so as to change the power mode of the host device 22 from the normal power mode to a power saving mode.

According to another embodiment of the present invention, the host device 22 further includes a timing unit 228, as shown in FIG. 2. The timing unit 228 is configured to generate a preset time interval, for example, 10 minutes, after the peripheral device 24 enters the idle status. Within the preset time interval, if the peripheral device 24 does not receive or transmit a packet, the peripheral device 24 transmits an IRP to the filter driver 226. The filter driver 226 receives the IRP and then sends a PIRP2 to the CPU 222, so as to cause the host device 22 to operate in the power saving mode.

In conclusion, without changing a conventional driver of a computer system, the present invention changes a power mode of the computer system by adding a filter driver to generate a PIRP to a CPU. By using an architecture disclosed in the present invention, when a peripheral device is attached but is not used, the computer system can enter a power saving mode to reduce the power consumption.

The technical content and technical features of the present invention are disclosed. However, persons skilled in the art may still make other replacements and modifications without departing from the spirit of the present invention based on the disclosure and teachings of the invention. Therefore, the scope of the present invention shall not be limited to the embodiments disclosed. Rather, the scope of the present invention shall include all the replacements and modifications without departing from the present invention and shall be covered by the appended claims.

What is claimed is:

1. A power management module, applied to set up a power mode of a computer system, wherein the computer system has a Universal Serial Bus (USB) for connecting a peripheral device, the power management module comprising:
an Operating System (OS), configured to set up the power mode of the computer system; and
a filter driver, configured to change the power mode of the computer system according to a packet transmitting/receiving status of the peripheral device.

2. The power management module according to claim 1, wherein when the peripheral device receives or transmits a packet, the OS sends a first Power I/O Request Packet (PIRP), so as to set up the computer system to operate in a normal power mode.

3. The power management module according to claim 1, wherein when the peripheral device is in an idle status, the filter driver sends a second PIRP, so as to cause the computer system to operate in a power saving mode.

4. The power management module according to claim 3, further comprising a timing unit, configured to generate a preset time interval after the peripheral device enters the idle status, wherein within the preset time interval, if the peripheral device remains in the idle status, the peripheral device sends an I/O Request Packet (IRP) to the filter driver, so as to cause the computer system to operate in the power saving mode.

5. A Universal Serial Bus (USB) system, comprising:
a peripheral device; and
a host device, communicating with the peripheral device through a USB, the host device comprising:
an Operating System (OS), configured to set up a power mode of the host device; and
a filter driver, configured to change the power mode of the host device according to a packet transmitting/receiving status of the peripheral device.

6. The USB system according to claim 5, wherein when the peripheral device receives or transmits a packet, the OS sends a first Power I/O Request Packet (PIRP), so as to set up the host device to operate in a normal power mode.

7. The USB system according to claim 5, wherein when the peripheral device is in an idle status, the filter driver sends a second PIRP, so as to cause the host device to operate in a power saving mode.

8. The USB system according to claim 7, wherein the host device further comprises a timing unit, configured to generate a preset time interval after the peripheral device enters the idle status; and within the preset time interval, if the peripheral device remains in the idle status, the peripheral device sends an I/O Request Packet (IRP) to the filter driver, so as to cause the host device to operate in the power saving mode.

9. A power management method, configured to set up a power mode of a computer system, wherein the computer system has a Universal Serial Bus (USB) for connecting a peripheral device, the method comprising the steps of:
detecting a packet transmitting/receiving status of the peripheral device through a filter driver;
generating a Power I/O Request Packet (PIRP) through the filter driver when the peripheral device is not receiving or transmitting a packet; and
changing the mode of the computer system from a normal power mode to a power saving mode according to the PIRP.

10. The power management method according to claim 9, wherein the generating step further comprises:
generating a preset time interval when the peripheral device is not receiving or transmitting a packet; and
transmitting a power I/O Request Packet (PIRP) by the filter driver, if the peripheral device does not receive or transmit a packet continuously within the preset time interval.

11. The power management method according to claim 9, wherein when the peripheral device starts receiving or transmitting a packet, the computer system changes to a normal power mode from the power saving mode.
